(19) United States
(12) Patent Application Publication
(10) Pub. No.: US 2026/0369985 A1
(43) Pub. Date: Nov. 19, 2026

(54) ENERGY STORAGE APPARATUS

(71) Applicant: GS YUASA International Ltd., Kyoto-shi, Kyoto (JP)

(72) Inventor: Ryuichi ITO, Kyoto-shi, Kyoto (JP)

(21) Appl. No.: 19/138,028

(22) PCT Filed: Dec. 5, 2023
(86) PCT No.: PCT/JP2023/043378

§ 371 Date: Jun. 11, 2025

(30) Foreign Application Priority Data
Dec. 13, 2022 (JP) 2022-198483

(51) Int. Cl. H02H 7/18; B60R 16/033; H01M 10/42

(52) U.S. Cl. CPC H02H 7/18; H01M 10/425; B60R 16/033; H01M 2010/4271; H01M 2220/20

(57) ABSTRACT

An energy storage apparatus includes a cell; a first current cutoff circuit positioned on a current path of the cell; a second current cutoff circuit connected in parallel with the first current cutoff circuit, and having lower current capacity and power consumption than the first current cutoff circuit; and a control unit. The second current cutoff circuit includes a current limiting device, and in a case where a current of the energy storage apparatus is lower than a predetermined value, the control unit opens the first current cutoff circuit and closes the second current cutoff circuit.

### CROSS REFERENCE TO RELATED APPLICATIONS

This application is a National Stage Application, filed under 35 U.S.C. § 371, of International Application No. PCT/JP 2023/043378, filed Dec. 5, 2023, which international application claims priority to and the benefit of Japanese Application No. 2022-198483, filed Dec. 13, 2022; the contents of both of which are hereby incorporated by reference in their entirety.

### BACKGROUND

### Technical Field

The present disclosure relates to a technology to reduce power consumption of the energy storage apparatus.

### Description of Related Art

An energy storage apparatus mounted in an automobile, etc. has a current cutoff circuit, such as an FET. Upon detection of abnormalities such as over-discharge, over-charge, the energy storage apparatus can be protected by opening the current cutoff circuit and interrupting the current. International Application Publication No. WO2011/158894 is a document disclosing this type of technology.

### BRIEF SUMMARY

An energy storage apparatus outputs differently depending on its operating status, and the like. For example, during parking, it is sufficient if low current can be output, whereas in states other than parking, such as traveling, higher current needs to be charged and discharged than during parking. When high current is output, usage of a current cutoff circuit with high current capacity can be considered.

However, a current cutoff circuit with high current capacity occasionally has high power consumption, and reducing power consumption has become a challenge. Energy storage apparatuses for devices other than vehicles also face the same challenge.

Disclosed are certain embodiments that attempt to reduce power consumption of an energy storage apparatus and reduce the likelihood of failure in a current cutoff circuit.

An energy storage apparatus includes: a cell; a first current cutoff circuit positioned on a current path of the cell; a second current cutoff circuit connected in parallel with the first current cutoff circuit, and having lower current capacity and power consumption than the first current cutoff circuit; and a control unit. The second current cutoff circuit includes a current limiting device.

In a case where a current of the energy storage apparatus is lower than a predetermined value, the control unit opens the first current cutoff circuit and closes the second current cutoff circuit. The current lower than a predetermined value includes zero current.

It is possible to reduce power consumption of an energy storage apparatus and reduce the failure in a current cutoff circuit.

### BRIEF DESCRIPTION OF THE FIGURES

FIG. 1 is a side view of an automobile.

FIG. 2 is a perspective view of a battery.

FIG. 3 is an exploded perspective view of a battery.

FIG. 4 is a block diagram illustrating an electrical configuration of the battery.

FIG. 5 is a circuit diagram when a first switch circuit is in parallel connection.

FIG. 6 illustrates details of a first drive circuit.

FIG. 7 illustrates details of a second drive circuit.

FIG. 8 is a table summarizing voltage control of a FET.

FIG. 9 compares performance of a first current cutoff circuit and a second current cutoff circuit.

FIG. 10 is a flowchart illustrating switch control of a current cutoff circuit.

FIG. 11 is a circuit diagram illustrating a charge and discharge path during parking.

FIG. 12 is a circuit diagram illustrating a charge and discharge path in other states than during parking.

FIG. 13 is a block diagram illustrating an electrical configuration of a battery.

### DETAILED DESCRIPTION OF VARIOUS EMBODIMENTS

### (Outline of Present Embodiment)

(1) An energy storage apparatus according to an embodiment of the present invention includes a cell; a first current cutoff circuit positioned on a current path of the cell; a second current cutoff circuit connected in parallel with the first current cutoff circuit, and having lower current capacity and power consumption than the first current cutoff circuit; and a control unit. The second current cutoff circuit includes a current limiting device.

In a case where current of the energy storage apparatus is lower than a predetermined value, the control unit opens the first current cutoff circuit and closes the second current cutoff circuit. The current lower than a predetermined value includes zero current.

According to the energy storage apparatus according to an embodiment of the present invention, in a case where the current is lower than a predetermined value, the control unit opens the first current cutoff circuit having high power consumption, and closes the second current cutoff circuit having low power consumption, which helps reduce the power consumption of the energy storage apparatus. Since the second current cutoff circuit includes a current limiting device, even when external short circuits or other abnormalities occur while the second current cutoff circuit is closed, the current can be limited. Thus, the failure in the second current cutoff circuit can be reduced.

(2) In the energy storage apparatus as described in above (1), a configuration is possible in which the current limiting device is a current limiting resistance, and the control unit measures current on the basis of voltage across two terminals of the current limiting resistance.

According to the energy storage apparatus described in (2), by using a high resistance for the current limiting resistance, a high voltage occurs with a low current. This enables measurement of low current with high accuracy.

(3) In the energy storage apparatus as described in above (2), a configuration is possible in which the energy storage apparatus includes a current sensor that measures the current of the energy storage apparatus, and the control unit corrects a measured current value of the current sensor on the basis of a measured current value of the current limiting device.

According to the energy storage apparatus described in (3), the current measurement accuracy of the current sensor can improve. By improving the current measurement accuracy, the estimation accuracy of the SOC, etc. calculated based on the measured current value can improve.

(4) In the energy storage apparatus as described in any one of above (1) to (3), a configuration is possible in which, in a case where the current of the energy storage apparatus is the predetermined value or higher, the control unit closes the first current cutoff circuit and opens the second current cutoff circuit. According to the energy storage apparatus described in (4), the current having a predetermined value or higher flows through the first current cutoff circuit having high current capacity and does not flow through the second current cutoff circuit having low current capacity. Therefore, the second current cutoff circuit is prevented from overheating.

(5) In the energy storage apparatus as described in any one of above (1) to (4), a configuration is possible in which the first current cutoff circuit includes: an N-channel FET disposed on a high side of the cell; and a first drive circuit that drives the N-channel FET, and the second current cutoff circuit includes: a P-channel FET connected in parallel with the N-channel FET; a second drive circuit that drives the P-channel FET; and the current limiting device.

According to the energy storage apparatus described in (5), the N-channel FET is disposed on a high side of the cell. The energy storage apparatus, in which the N-channel FET is disposed on a high side of the cell, has to continually apply higher voltage to the gate than to the cell in order to maintain the FET in a closed state. Therefore, the power consumption of the first drive circuit to drive the FET is high. When certain embodiments of the present invention are applied to an energy storage apparatus in which the N-channel FET is disposed on a high side of the cell, when the current is lower than a predetermined value, the power consumption of the first drive circuit can still be reduced by using the P-channel FET.

(6) The energy storage apparatus as described in any one of above (1) to (5) may be for use with a vehicle. A configuration is possible in which, while the vehicle is parked, the control unit opens the first current cutoff circuit and closes the second current cutoff circuit.

According to the energy storage apparatus described in (6), the power consumption during parking can be reduced.

(7) The energy storage apparatus as described in any one of above (1) to (6) may be for use with a vehicle. A configuration is possible in which, when the energy storage apparatus is not mounted on a vehicle or when the energy storage apparatus is detached from a vehicle, the control unit opens the first current cutoff circuit and closes the second current cutoff circuit.

The energy storage apparatus described in (7) can reduce standby power in cases where the energy storage apparatus is at zero current, such as before the energy storage apparatus is mounted on a vehicle or when the energy apparatus is detached from a vehicle.

### FIRST EMBODIMENT

### 1. Description of Battery

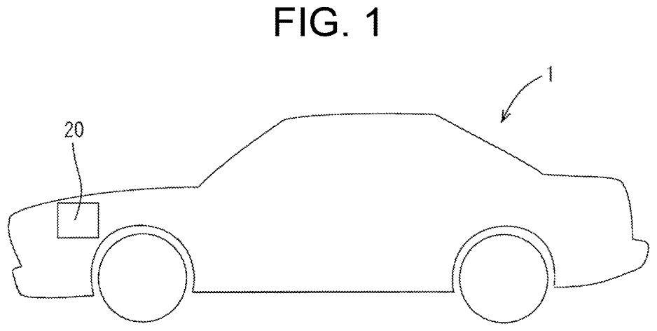

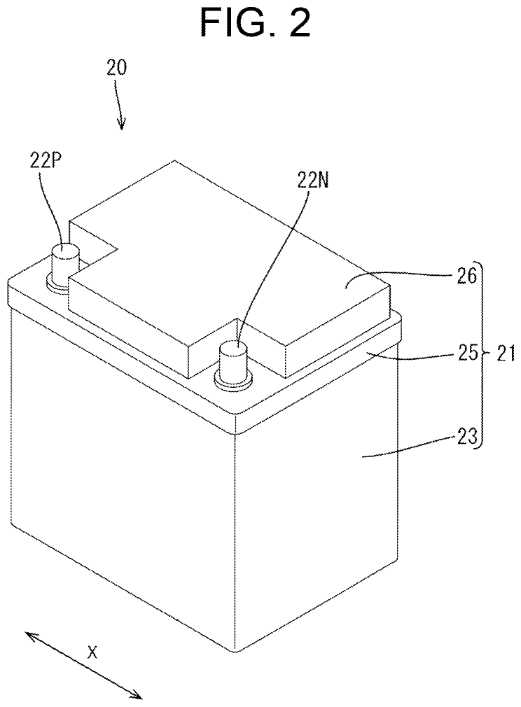

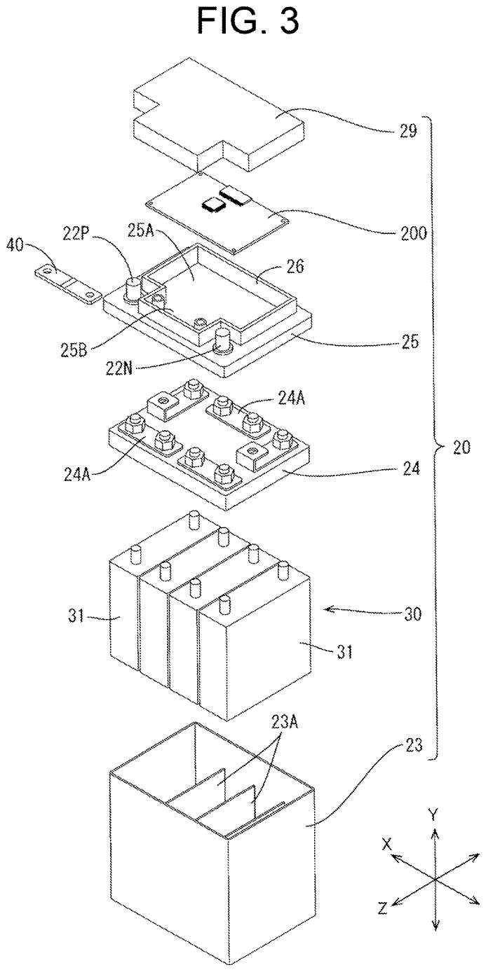

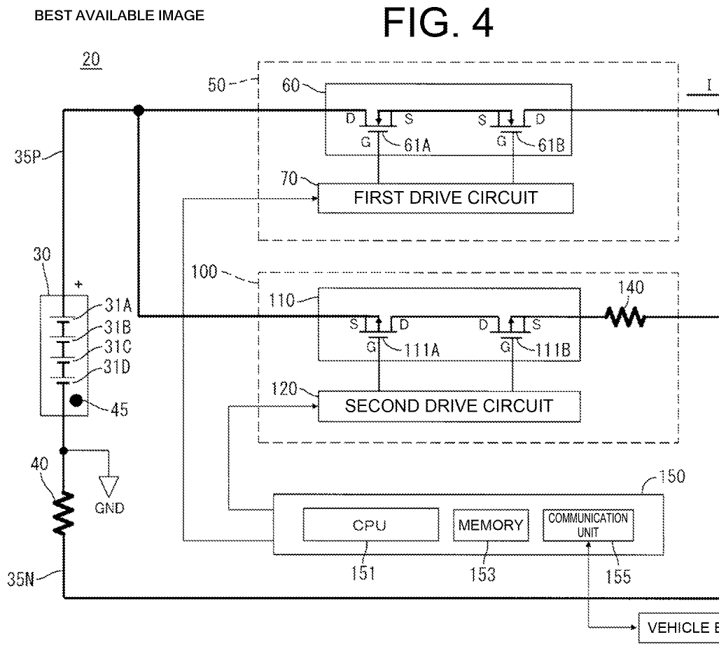

FIG. 1 is a side view of an automobile, FIG. 2 is a perspective view of a battery, FIG. 3 is an exploded perspective view of a battery, and FIG. 4 is a block diagram illustrating an electrical configuration of the battery. In FIG. 1, only an automobile 1 and a battery 20 are illustrated, but no other component constituting the automobile is illustrated.

As illustrated in FIG. 1, the automobile (an example of a vehicle) 1 includes a battery 20, being an energy storage apparatus. As illustrated in FIG. 2, the battery 20 includes a battery case 21 in a block shape, and an assembled battery 30 and a circuit board 200, made of a plurality of cells 31, are accommodated in the battery case 21.

In the following description, when referring to FIG. 2 and FIG. 3, an up-down direction of the battery case 21 when the battery case 21 is placed in a horizontal orientation without being tilted with respect to a mounting surface is assumed to be Y-direction; a direction which is along a long-side direction of the battery case 21 is assumed to be X-direction; and a depth direction of the battery case 21 is assumed to be Z-direction.

As illustrated in FIG. 3, the battery case 21 includes: a box-shaped case main-body 23 opening upward; a positioning member 24 to position the plurality of cells 31; an inner lid 25 to be mounted on an upper part of the case main-body 23; and an upper lid 29 to be mounted on an upper part of the inner lid 25. Inside the case main-body 23, a plurality of cell chambers 23A separately accommodating therein cells 31 are provided in line in X-direction.

As illustrated in FIG. 3, a plurality of bus bars 24A align on an upper surface of the positioning member 24, and the positioning member 24 is disposed on an upper portion of the plurality of cells 31 aligning in the case main-body 23. Therefore, the plurality of cells 31 are positioned and are connected in series by the plurality of bus bars 24A.

As illustrated in FIG. 3, the inner lid 25 has a rectangular shape in plan view, and has provided on both ends thereof in X-direction with a pair of external terminals 22P and 22N connected to a harness terminals not illustrated. For example, the pair of external terminals 22P and 22N are made of metal such as a lead alloy, and 22P represents a positive electrode and 22N represents a negative electrode.

As illustrated in FIG. 3, the circuit board 200 is disposed on an upper surface of the inner lid 25, and the upper lid 29 closes the upper portion thereof.

FIG. 4 is a block diagram illustrating an electrical configuration of the battery 20. The battery 20 includes an assembled battery 30, a voltage measurement unit (not illustrated), current sensor 40, a temperature sensor 45, a first current cutoff circuit 50, a second current cutoff circuit 100, and a management device 150.

The assembled battery 30 has four cells 31, for example (refer to FIG. 2), which are connected in four series. The cell is not limited to a prismatic cell, and may be a cylindrical cell or a pouch cell having a laminated film case. The cell 31 is, for example, a lithium-ion secondary battery cell.

The assembled battery 30, the current sensor 40 and the first current cutoff circuit 50 are connected in series, via the power line 35P and the power line 35N.

As illustrated in FIG. 4, the power line 35P connects the positive electrode external terminal 22P and the positive electrode of the assembled battery 30. The power line 35N connects the negative electrode external terminal 22N and the negative electrode of the assembled battery 30. The external terminals 22P and 22N are terminals for connection with the automobile 1, and can electrically connect to a load 15 or an alternator 16, which are vehicle-mounted, via the external terminals 22P and 22N. The load 15 includes an engine starting device and auxiliary machines.

The current sensor 40 is provided on the negative power line 35N. The current sensor 40 may be a shunt resistance. The resistance-type current sensor 40 can measure a current I of the assembled battery 30, on the basis of voltage across two terminals of a resistance. Alternatively, the current sensor 40 may be a magnetic sensor.

The voltage measurement unit (not illustrated) measures a voltage of the assembled battery 30. The temperature sensor 45 is attached to the assembled battery 30, and detects the temperature of the assembled battery 30 or the surroundings thereof.

The first current cutoff circuit 50 is mounted on the circuit board 200, and is provided on the positive power line 35P. The first current cutoff circuit 50 is a circuit to interrupt the current I from the battery 20. The first current cutoff circuit 50 is detailed below.

The management device 150 is mounted on the circuit board 200, and as illustrated in FIG. 4, includes a CPU 151, a memory 153, and a communication unit 155. The management device 150 corresponds to a “control unit” in certain embodiments of the present invention.

The management device 150 monitors the state of the battery 20 on the basis of the outputs of the voltage measurement unit, the current sensor 40, and the temperature sensor 45. The management device 150 calculates the SOC [%] of the battery 20, on the basis of the current I of the battery 20. The SOC (state of charge) is a ratio of a remaining capacity [Ah] relative to a full-charge capacity [Ah].

The communication unit 155 is used for communication and connection with the vehicle ECU 16. The vehicle electronic control unit (ECU) 16 is mounted on the automobile 1, and controls the automobile 1. The management device 150 can acquire information regarding a state of the automobile 1 (parking, traveling, stopping, etc.) by communication with the vehicle ECU 16.

The memory 153 stores therein a monitoring program for the battery 20, a switching program for the current cutoff circuits 50 and 100, and data required for execution of these programs.

The program may be stored in a recording medium such as a CD-ROM to be used, transferred, lent, or the like. The program may be distributed by using a telecommunication line.

### 2. Configuration of First Current Cutoff Circuit 50 and Second Current Cutoff Circuit 100

The first current cutoff circuit 50 is positioned in the positive electrode (high side) of the assembled battery 30, and includes a first switch circuit 60 and a first drive circuit 70.

The first switch circuit 60 is an N-channel field-effect transistor (FET). In the present embodiment, the first switch circuit 60 includes two FETs 61A and 61B.

A drain of the FET 61A is connected to a positive electrode of the assembled battery 30, and a drain of the FET 61B is connected to a positive electrode external terminal 22P. Respective sources of the two FETs 61A and 61B are connected to each other, and the two FETs 61A and 61B are in back-to-back connection. Back-to-back connection is connection between drains or sources of two FETs.

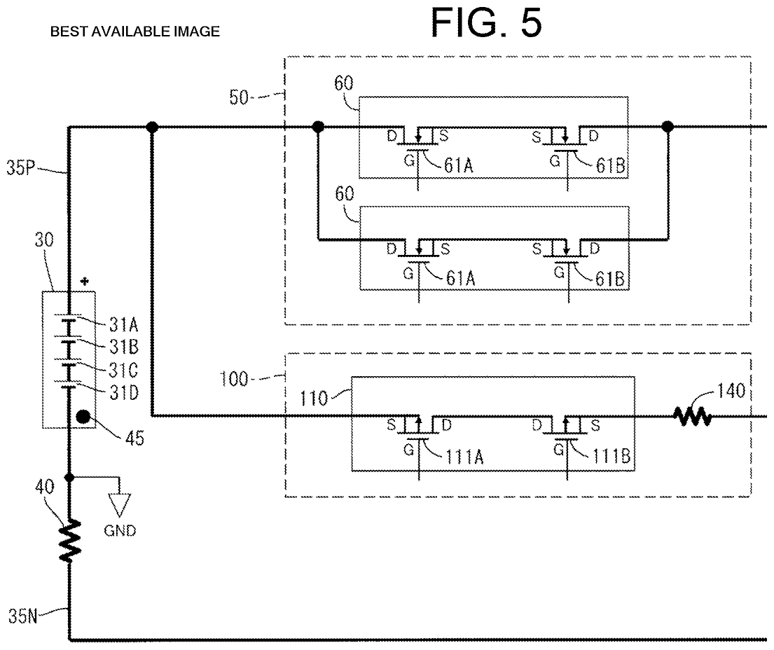

As illustrated in FIG. 5, the first current cutoff circuit 50 may take a form in which a plurality of first switch circuits 60 are connected in parallel. By connecting the plurality of first switch circuits 60 in parallel, the current capacity [A] of the first current cutoff circuit 50 can be increased.

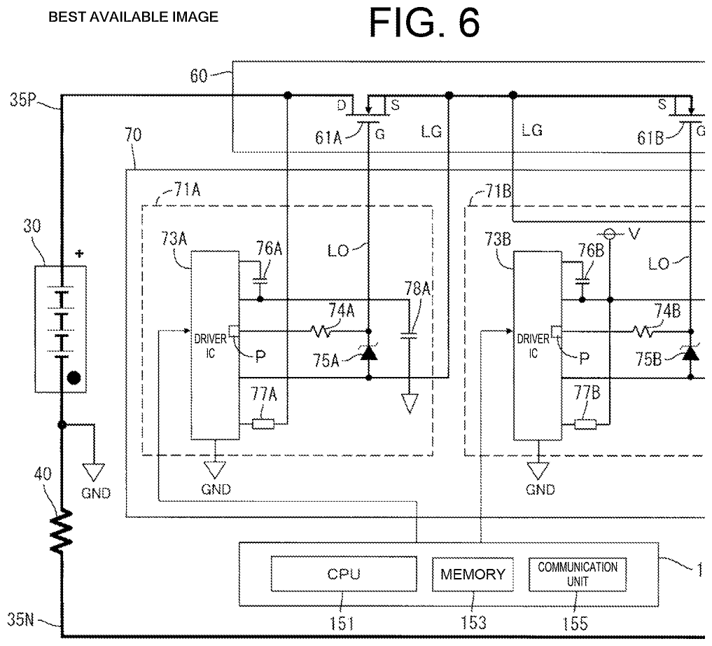

FIG. 6 illustrates details of a first drive circuit 70 (the second drive circuit 120 not illustrated). The first drive circuit 70 is a drive circuit of the first switch circuit 60. The first drive circuit 70 operates, with the assembled battery 30 as a power source, and includes two IC circuits 71A and 71B. The IC circuit 71A is used to drive the FET 61A, and the IC circuit 71B is used to drive the FET 61B.

The IC circuit 71A includes a gate driver IC 73A which drives a gate of the first switch circuit 60, and its peripheral circuitry. The gate driver IC 73A includes an output port P to apply a high voltage to a gate. The peripheral circuitry includes a gate resistance 74A, a Zener diode 75A, a capacitor 76A, an inductor 77A, a capacitor 78A, and the like. A line LG represents a voltage reference line, and a line LO represents an output line for a control signal.

The Zener diode 75A is provided to stabilize the gate voltage. The capacitor 76A, the inductor 77A, and the capacitor 78A are each a filter. The IC circuit 71B has the same configuration as the IC circuit 71A.

The management device 150 applies a predetermined positive voltage to the gate of the FET 61A via the gate driver IC 73A, to control so that Vgs>Vgs(th), to control the FET 61A to be in a closed state. The predetermined positive voltage is, for example, a voltage approximately 10V higher than a positive electrode voltage 12V of the assembled battery 30, and is about 20V. Vgs(th) is a threshold voltage (threshold value voltage) of the FET 61A and the FET 61B.

The management device 150 can control the FET 61A to be in an open state by controlling the gate voltage by the gate driver IC 73A so that Vgs<Vgs(th). In addition, the management device 150 can control the FET 61B to be in a closed state or an open state by controlling the gate voltage of the FET 61B via the gate driver IC 73B.

As illustrated in FIG. 4, the second current cutoff circuit 100 is connected in parallel with the first current cutoff circuit 50. The second current cutoff circuit 100 includes a second switch circuit 110 and a second drive circuit 120.

The second switch circuit 110 is a P-channel field-effect transistor (FET). In the present embodiment, the second switch circuit 110 includes two FETs 111A and 111B.

A source of the FET 111A is connected to the positive electrode of the assembled battery 30, and a source of the FET 111B is connected to the positive electrode external terminal 22P. Respective drains of the two FETs 111A and 111B are connected to each other, and the two FETs 111A and 111B are in back-to-back connection. The two FETs 111A and 111B are closed by controlling the gate voltage so that Vgs≤-Vgs(th) by the second drive circuit 120. The two FETs 111A and 111B are opened by controlling the gate voltage so that Vgs>-Vgs(th). Vgs(th) is a threshold voltage of the FETs 111A and 111B.

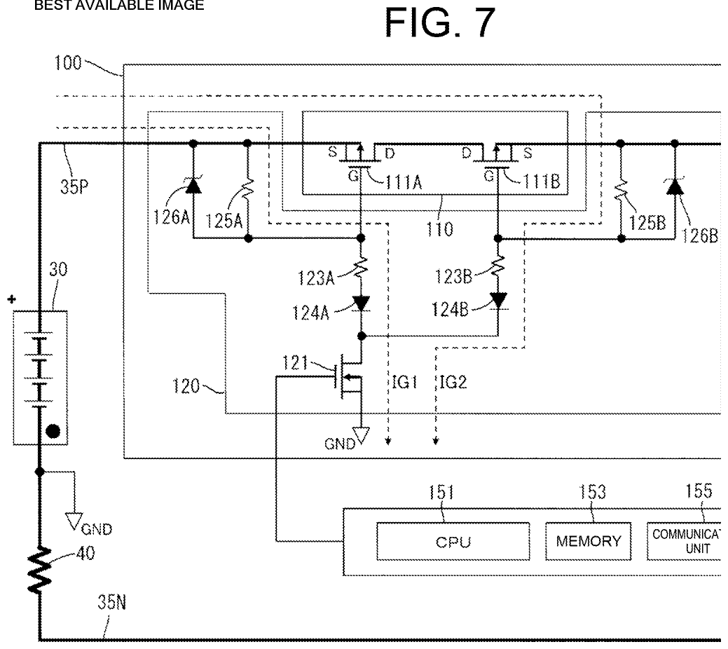

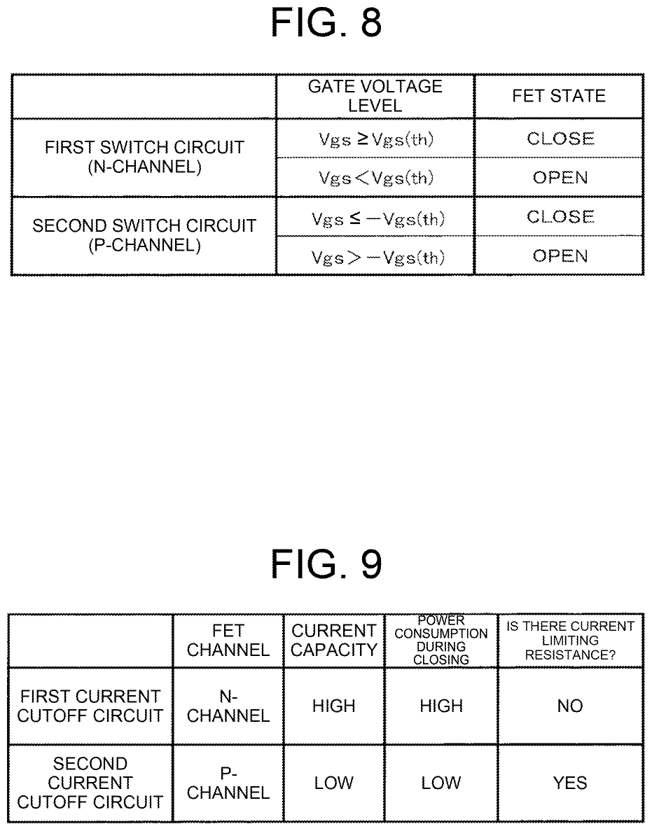

FIG. 7 is a circuit diagram of the second drive circuit 120 (the first drive circuit 70 not illustrated). The second drive circuit 120 is a drive circuit of the second switch circuit 110. The second drive circuit 120 operates, with the assembled battery 30 as a power source, and as illustrated in FIG. 7, includes a switch 121, gate resistances 123A and 123B, diodes 124A and 124B, gate source resistances 125A and 125B, and Zener diodes 126A and 126B.

The switch 121 is an N-channel FET. The gate resistance 123A connects a gate of the FET 111A to a drain of the switch 121. The diode 124A is provided between the gate of the FET 111A and the drain of the switch 121. The diode 124A has an anode connected to the gate of the FET 111A and a cathode connected to the drain of the switch 121.

The gate source resistance 125A is connected between the gate and the source of the FET 111A. The gate resistance 123A and the gate source resistance 125A makes up a voltage divider circuit.

When the switch 121 is turned ON, a current IG1 flows through a path along the assembled battery 30, the gate source resistance 125A, the gate resistance 123A, the diode 124A, and the switch 121, and a voltage divided from a positive electrode voltage of the assembled battery 30 is generated on the gate of the FET 111A. As a result, the FET 111A is brought into the state Vgs≤-Vgs(th), and the FET 111A is closed.

When the switch 121 is turned ON, the gate voltage of the FET 111B decreases, and the FET 111B is also brought into the state Vgs≤-Vgs(th), similarly to the FET 111A, and the FET 111B is closed.

Therefore, in addition to the above-mentioned path, a current IG2 flows through a path along the assembled battery 30, the FETs 111A and 111B, the gate source resistance 125B, the gate resistance 123B, the diode 124B, and the switch 121. The current IG1, IG2 maintains the state Vgs≤-Vgs(th), and the two FETs 111A and 111B are maintained in the closed state.

As a combined resistance value of the gate resistance 123A and the gate source resistance 125A increases, the current IG1, IG2 decreases, and the power consumption of the second drive circuit 120 can be reduced (the same applies to a case where a combined resistance value of the gate resistance 123B and the gate source resistance 125B increases).

When the switch 121 is turned OFF, the current IG1 is shut off so that Vgs>-Vgs(th), and therefore the FET 111A opens. Similarly to the FET 111A, also in the case of the FET 111B, when the switch 121 is turned OFF, the FET 111B can be controlled to open.

The second current cutoff circuit 100 includes a current limiting resistance 140, in addition to the second switch circuit 110 and the second drive circuit 120. The current limiting resistance 140 is connected in series with the second switch circuit 110, and limits the current I of the second current cutoff circuit 100. In one example, the current limiting resistance 140 is a high resistance of about 100 Ω.

FIG. 9 compares performance of the first current cutoff circuit 50 and the second current cutoff circuit 100. The first current cutoff circuit 50 and the second current cutoff circuit 100 are different in current capacity and power consumption. The second current cutoff circuit 100 is lower in current capacity than the first current cutoff circuit 50, and has lower power consumption during the closed state. The current capacity is the maximum current allowed to be flow through the current cutoff circuit, and is represented in the unit [A].

The reason why the two circuits 50 and 100 differ in current capacity and power consumption is that the switch circuits 60 and 110 use different FET channels. Specifically, the first switch circuit 60 of the first current cutoff circuit 50 uses an N-channel FET exhibiting low on-resistance between the source and drain, and therefore the current capacity is high. In addition, since the N-channel FET is disposed on a high side (positive electrode side) of the assembled battery 30, in order to maintain the closed state, a voltage of about 20V has to be continually applied to the gate by the gate driver IC or a booster converter, and therefore the consumption power of the first drive circuit 70 becomes high.

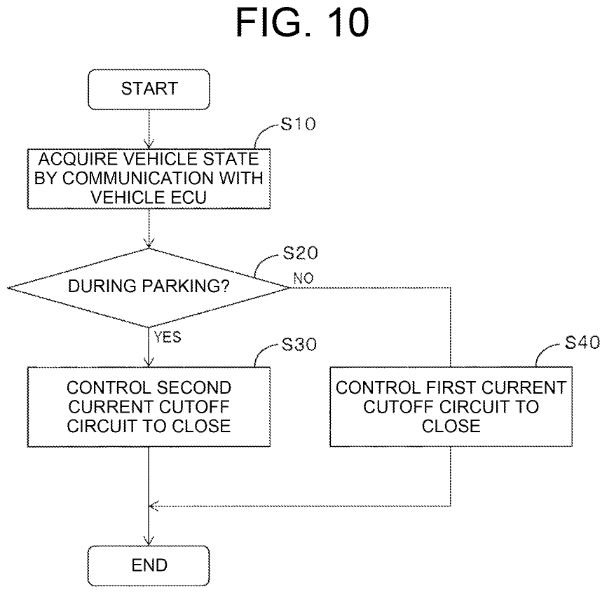

FIG. 10 is a flowchart illustrating switch control of a current cutoff circuit. Switch control of the current cutoff circuit is made up of four steps of S10 to S40, which is executed, for example, when triggered by a start of communication with the vehicle ECU 16 when the battery 20 is mounted on the vehicle.

When switch control by the current cutoff circuit starts, the management device 150 accesses the vehicle ECU 16, and acquires the state of the automobile 1. In the present embodiment, as acquired state of the automobile 1 is whether the automobile 1 is parked, or in any other states.

During parking, the current supplied from the battery 20 to the automobile 1 is low current which is current lower than a predetermined value (for example, lower than 100 mA).

When the automobile 1 is parked, the management device 150 closes the P-channel FETs 111A and 111B of the second current cutoff circuit 100, and opens the N-channel FETs 61A and 61B of the first current cutoff circuit 50 (S30).

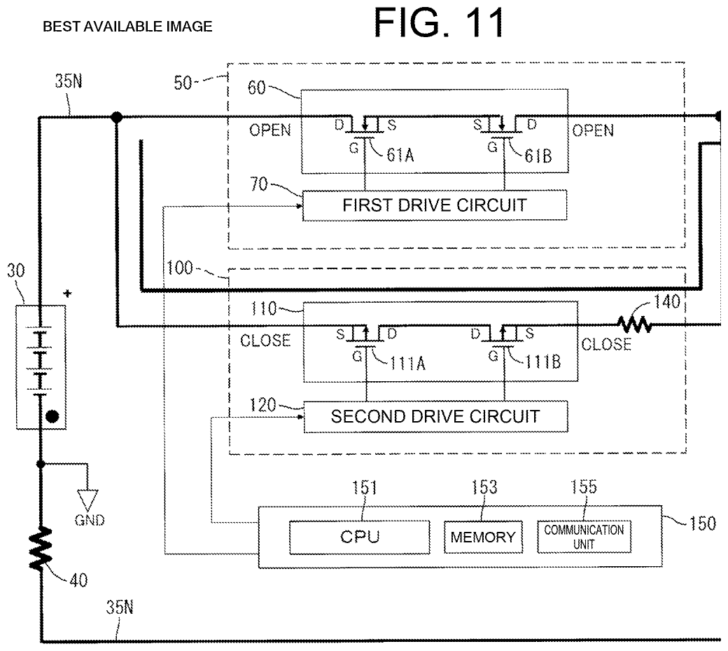

Accordingly, when the automobile 1 is parked, as illustrated in FIG. 11, the battery 20 charges and discharges on a path along the P-channel FETs 111A and 111B of the second current cutoff circuit 100.

When the N-channel FETs 61A and 61B are open, the gate does not have to be maintained at a high voltage. Therefore, during parking, it is possible to reduce power consumed by the first drive circuit 70.

The second current cutoff circuit 100 includes a current limiting resistance 140 which is in series with the P-channel FETs 111A and 111B. By including the current limiting resistance 140, even when external short circuits or other abnormalities occur while the second current cutoff circuit 100 is closed, no abnormal high current flows through the P-channel FETs 111A and 111B, and the likelihood of failure in the second current cutoff circuit 100 can be reduced.

While the automobile 1 is traveling or in other states than while the automobile 1 is parked, the current I supplied from the battery 20 to the automobile 1 is higher than that while the automobile 1 is parked, and is a predetermine value or higher (for example, about several amperes (A)).

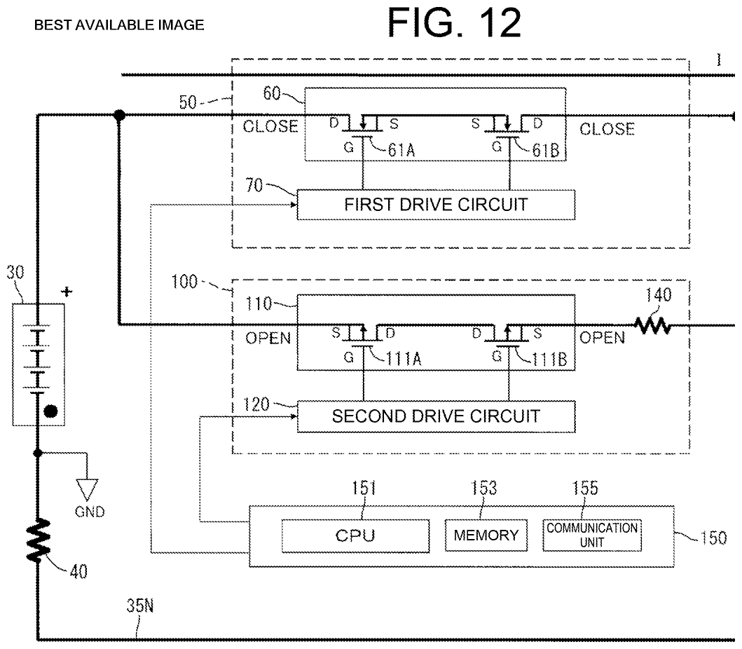

While the automobile 1 is traveling or in other states than while the automobile 1 is parked, the management device 150 closes the first current cutoff circuit 50, and opens the second current cutoff circuit 100 (S40). Accordingly, when the automobile 1 is in other states than while the automobile 1 is parked, as illustrated in FIG. 12, the battery 20 charges and discharges on a path along the N-channel FETs 61A and 61B of the first current cutoff circuit 50.

Since the N-channel FETs 61A and 61B of the first current cutoff circuit 50 are higher in current capacity than the P-channel FETs 111A and 111B of the second current cutoff circuit 100, a high-current charging and discharging is possible.

### 4. Effect

The present configuration can reduce power consumption of the battery 20 and reduce the likelihood of failure in the second current cutoff circuit 100.

### SECOND EMBODIMENT

Normally, the current sensor 40 mounted on the power line 35 of the battery 20 has a wide current measurement range. For example, if the battery 20 is intended to start an engine, an engine starting current is approximately 1000 A, and the measurement range of the current sensor 40 required exceeds this value, for example, around 1500 A. The current sensor 40 can measure high current, and therefore the resistance value is low as about 100 μΩ, and therefore the current sensor 40 is not suited for measuring minute current.

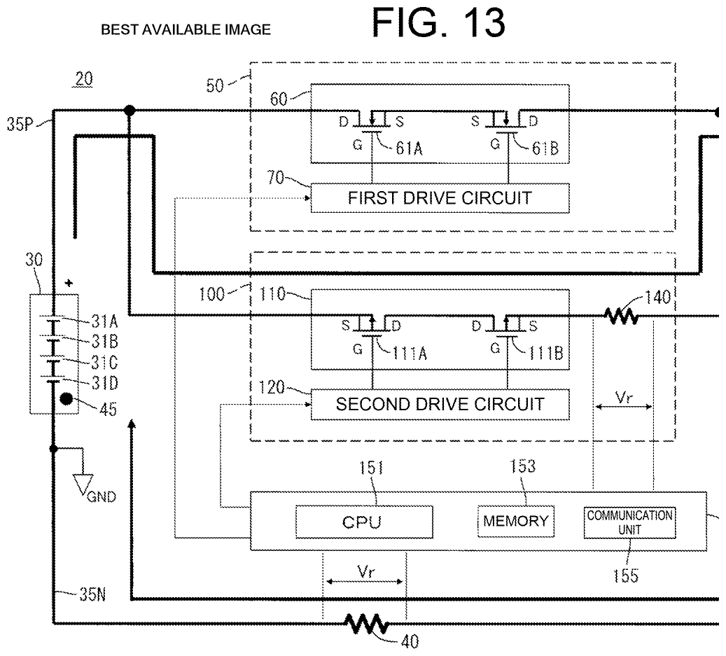

The second embodiment is different from the first embodiment in that the second embodiment uses the current limiting resistance 140 to measure current. As illustrated in FIG. 13, both ends of the current limiting resistance 140 are connected to the management device 150 via a signal line Ls.

The management device 150 measures current in the second current cutoff circuit 100, on the basis of the voltage across two terminals Vr of the current limiting resistance 140.

In an example, the resistance value of the current limiting resistance 140 is about 100 Ω, which is higher than the resistance value of the current sensor 40 (about 100 μΩ), and high voltage at two terminals Vr occurs for a same current. Therefore, it is possible to highly accurately measure the current to be discharged (dark current during parking) by the battery 20 with respect to the automobile 1 while the second current cutoff circuit 100 is closed.

By improving the current measurement accuracy, estimation accuracy of the SOC, etc. to be calculated based on the measured current value can improve.

In addition, as illustrated in FIG. 13, while the second current cutoff circuit 100 is closed, the current I flows through the current sensor 40 and the current limiting resistance 140, the current I can be measured not only in the current limiting resistance 140 but also in the current sensor 40.

The management device 150 compares the measured current value Il of the current sensor 40 with the measured current value I2 of the current limiting resistance 140 and obtains an error ϵ of the measured current value I1, thereby correcting the error ϵ of the measured current value I1 of the current sensor 40.

ϵ=I1−I2

By correcting the error ϵ, while the first current cutoff circuit 50 is closed (in this example, in other states than during parking), the current measurement accuracy of the current sensor 40 can improve.

### OTHER EMBODIMENTS

The present invention is not limited to the embodiments explained with reference to the above description and the drawings, and the technical scope of the present invention also incorporates therein, for example, the following embodiments.

(1) The cell (repeatedly chargeable and dischargeable energy storage cell) 31 is not limited to a lithium ion secondary battery cell, and may be other non-aqueous electrolyte secondary battery cells. Instead of the secondary battery cell 31, a capacitor may be used.

(2) In the above-described first and second embodiments, the battery 20 is for use with a vehicle. The battery 20 is not limited to those for use with a vehicle, and may be for other usages. Further, the battery 20 may be used for a stationary application such as an energy storage apparatus for fluctuation absorption in a distributed power generation system, or an uninterruptible power supply (UPS). When this technology is used for the UPS, during normal operation of the commercial power source, the second current cutoff circuit 100 is closed (the first current cutoff circuit 50 is open), and trickle charging of the battery 20 at low current lower than a predetermined value may be performed on a path along the second current cutoff circuit 100. At abnormal times such as during a power outage, such measure is also possible in which the first current cutoff circuit 50 is closed (the second current cutoff circuit 100 is open), and discharge of the battery 20 is performed at high current of a predetermined value or higher on a path along the first current cutoff circuit 50.

(3) In the above-described first and second embodiments, when the battery 20 is used in the automobile 10 which is parked, the first current cutoff circuit 50 is open, and the second current cutoff circuit 100 is closed. In other cases, for example before the battery 20 is mounted on the automobile 10 (for example during transportation of the battery), or when the battery 20 is detached from the automobile 10, such measure is possible in which the first current cutoff circuit 50 is open, and the second current cutoff circuit 100 is closed. By taking such measure, it is possible to reduce the standby power when the battery is at zero current. The attachment and detachment to and from the automobile 10 can be determined from the state of communication with the vehicle ECU 16. For example, when no communication is performed with the vehicle ECU 16 at all, it can be determined that it is before mounting to the automobile 10. When there is no communication with the vehicle ECU 16 for a predetermined time or more after starting of the communication with the vehicle ECU 16, the battery 20 can be determined to have been detached from the automobile 10.

(4) In the above-described first and second embodiments, when the automobile 1 is parked, the second current cutoff circuit 100 is closed. When the current I is lower than a predetermined value, such measure can be taken in which the second current cutoff circuit 100 is closed and charge and discharge is performed for the battery 20 on a path along the second current cutoff circuit 100, even in other cases than during parking. It is possible to determine whether the current I is lower than a predetermined value on the basis of the measured value of the current sensor 40.

(5) In the above-described first and second embodiments, the current I of the second current cutoff circuit 100 is limited by the current limiting resistance 140. The current limiting resistance 140 can be replaced by any device which can limit the current I.

(6) In the above-described second embodiment, the measured current value I1 of the current sensor 40 is corrected by using the measured current value I2 of the current limiting resistance 140. The occurrence of failure in the current sensor 40 can be determined by using the measured current value I2 of the current limiting resistance 140. For example, when the difference between the two measured current values (I1-I2) is larger than an allowable value, the current sensor 40 can be determined to have caused a failure.

(7) In the above-described first and second embodiments, the first switch circuit 60 is assumed to be the two N-channel FETs 61A and 61B in back-to-back connection, and the second switch circuit 110 is assumed to be the two P-channel FETs 110A and 110B in back-to-back connection. The first switch circuit 60 and the second switch circuit 110 are not limited to the configuration disclosed in the embodiments. Any other configuration may be utilized, as long as it has a current capacity which satisfies the relation in FIG. 9. The same thing can be said for the first drive circuit 70 and the second drive circuit 120, and they are also not limited to the configuration disclosed in the embodiments. Any other configuration may be utilized, as long as it has a power consumption which satisfies the relation in FIG. 9.

Moreover, in the above-described embodiments, the first current cutoff circuit 50 and the second current cutoff circuit 100 are disposed on a high side (positive electrode side) of the assembled battery 30, and the current sensor 40 is disposed on a low side (negative electrode side) of the assembled battery 30. A configuration is also possible in which the first current cutoff circuit 50 and the second current cutoff circuit 100 are disposed on a low side (negative electrode side) of the assembled battery 30, and the current sensor 40 is disposed on a high side (positive electrode side) of the assembled battery 30.

1. An energy storage apparatus, comprising:
a cell;
a first current cutoff circuit positioned on a current path of the cell;
a second current cutoff circuit connected in parallel with the first current cutoff circuit, and having lower current capacity and power consumption than the first current cutoff circuit; and
a control unit, wherein
the second current cutoff circuit includes a current limiting device, and
in a case where current of the energy storage apparatus is lower than a predetermined value, the control unit opens the first current cutoff circuit and closes the second current cutoff circuit.

2. The energy storage apparatus according to claim 1, wherein
the current limiting device is a current limiting resistance, and
the control unit measures current on the basis of voltage across two terminals of the current limiting resistance.

3. The energy storage apparatus according to claim 2, comprising
a current sensor that measures the current of the energy storage apparatus, wherein the current limiting device is a current limiting resistance,
the control unit measures current on the basis of voltage across two terminals of the current limiting resistance, and
the control unit corrects a measured current value of the current sensor on the basis of a measured current value of the current limiting device.

4. The energy storage apparatus according to claim 1, wherein
in a case where the current of the energy storage apparatus is the predetermined value or higher, the control unit closes the first current cutoff circuit and opens the second current cutoff circuit.

5. The energy storage apparatus according to claim wherein
the first current cutoff circuit includes:
an N-channel field-effect transistor (FET) disposed on a high side of the cell; and
a first drive circuit that drives the N-channel FET, and
the second current cutoff circuit includes:
a P-channel field-effect transistor (FET) connected in parallel with the N-channel FET;
a second drive circuit that drives the P-channel FET; and
the current limiting device.

6. The energy storage apparatus according to claim 1 which is for use with a vehicle, wherein
while the vehicle is parked, the control unit opens the first current cutoff circuit and closes the second current cutoff circuit.

7. The energy storage apparatus according to claim 1 which is for use with a vehicle,
when the energy storage apparatus is not mounted on the vehicle or when the energy storage apparatus is detached from the vehicle, the control unit opens the first current cutoff circuit and closes the second current cutoff circuit.
